(19) United States
(12) Patent Application Publication
(10) Pub. No.: US 2014/0317579 A1
(43) Pub. Date: Oct. 23, 2014

(54) METHODS, APPARATUSES, AND COMPUTER PROGRAM PRODUCTS FOR APPLICATION INTERACTION

(71) Applicant: McKesson Financial Holdings, Hamilton (BM)

(72) Inventor: Robert Scott Dickerson, Cary, NC (US)

(73) Assignee: McKesson Financial Holdings, Hamilton (BM)

(21) Appl. No.: 14/010,573

(22) Filed: Aug. 27, 2013

Related U.S. Application Data
(60) Provisional application No. 61/813,153, filed on Apr. 17, 2013.

(51) Int. Cl. G06F 3/01

(52) U.S. Cl. CPC G06F 3/01
USPC 715/867

(57) ABSTRACT

Methods, apparatuses, and computer program products are herein provided for enabling an application view, such as a current application view that contains personal or otherwise sensitive information to be protected with a screensaver in an instance in which a current application view is relegated to the background, minimized or the like, relegated to the background and/or the like. In some example embodiments, a method is provided that comprises receiving a deactivation notification for an application being displayed in a foreground of a device visible view. The method of this embodiment may also include determining that at least a portion of the current view of the application comprises sensitive information. The method of this embodiment may also include adding a screensaver view to an application view stack top, wherein the screensaver view is operable to at least partially obscure the sensitive information in at least a portion of the current view.

### CROSS REFERENCES TO RELATED APPLICATIONS

This application claims priority to U.S. Provisional Patent Application No. 61/813,153 filed on Apr. 17, 2013, the entirety of which is hereby incorporated by reference as if fully set forth herein.

### TECHNOLOGICAL FIELD

Embodiments of the present invention relate generally to application interaction and, more particularly, to methods, apparatuses, and computer program products for securing information in one or more application views.

### BACKGROUND

Applications comprise multiple views that themselves contain the potential for displaying private or otherwise sensitive data. In some examples, private or otherwise sensitive information may be displayed or otherwise accessible in an application irrespective of whether a user is currently viewing the particular application and/or whether the user is aware that the application is still active. In such cases, the privacy of a user may be violated in an instance in which another user access the application view that was minimized or otherwise delegated to the background. For example, an application containing a social security number may be relegated to the background, but still could be accessible to an identity thief.

In other examples, an application may be configured to display one or more images on one or more devices. Each of these devices may have a different form factor, include a different type of display or have different display characteristics. As such, an application developer may be required to store multiple image versions with each application instance so that an application is operable on each of the one or more devices. Such expanded storage may lead to excessive use of memory, upgrade and compatibility issues and/or the like.

### BRIEF SUMMARY OF SOME EXAMPLES OF THE INVENTION

Methods, apparatuses, and computer program products are herein provided for enabling an application view, such as a current application view that contains personal or otherwise sensitive information to be protected with a screensaver (e.g. a blank screen, a redacted screen, a picture or the like) in an instance in which a current application view is relegated to the background, minimized or the like, relegated to the background for a predetermined duration, is left open for a certain period where no activity is detected and/or the like. In some examples, the screensaver may be displayed unless or until a password, pin code or other challenge response is entered so as to protect the sensitive information.

In some example embodiments, a method is provided that comprises receiving a deactivation notification for an application being displayed in a foreground of a device visible view, the deactivation notification providing an indication that the application is to be pushed to the background. The method of this embodiment may also include determining that at least a portion of the current view of the application comprises sensitive information. The method of this embodiment may also include adding a screensaver view to an application view stack top, wherein the screensaver view is operable to at least partially obscure the sensitive information in at least a portion of the current view.

In further example embodiments, an apparatus is provided that includes at least one processor and at least one memory including computer program code with the at least one memory and the computer program code being configured, with the at least one processor, to cause the apparatus to at least receive a deactivation notification for an application being displayed in a foreground of a device visible view, the deactivation notification providing an indication that the application is to be pushed to the background. The at least one memory and computer program code may also be configured to, with the at least one processor, cause the apparatus to determine that at least a portion of the current view of the application comprises sensitive information. The at least one memory and computer program code may also be configured to, with the at least one processor, cause the apparatus to add a screensaver view to an application view stack top, wherein the screensaver view is operable to at least partially obscure the sensitive information in at least a portion of the current view.

In yet further example embodiments, a computer program product may be provided that includes at least one non-transitory computer-readable storage medium having computer-readable program instructions stored therein with the computer-readable program instructions including program instructions configured to at least receive a deactivation notification for an application being displayed in a foreground of a device visible view, the deactivation notification providing an indication that the application is to be pushed to the background. The computer-readable program instructions may also include program instructions configured to determine that at least a portion of the current view of the application comprises sensitive information. The computer-readable program instructions may also include program instructions configured to add a screensaver view to an application view stack top, wherein the screensaver view is operable to at least partially obscure the sensitive information in at least a portion of the current view.

In yet further example embodiments, an apparatus is provided that includes means for receiving a deactivation notification for an application being displayed in a foreground of a device visible view, the deactivation notification providing an indication that the application is to be pushed to the background. The apparatus of this embodiment may also include means for determining that at least a portion of the current view of the application comprises sensitive information. The apparatus of this embodiment may also include means for adding a screensaver view to an application view stack top, wherein the screensaver view is operable to at least partially obscure the sensitive information in at least a portion of the current view.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates an application according to some example embodiments of the present invention;

FIGS. 2-5 illustrate block diagrams according to example embodiments of the present invention; and

FIG. 6 illustrates a block diagram of circuitry according to some example embodiments of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, and/or the like.

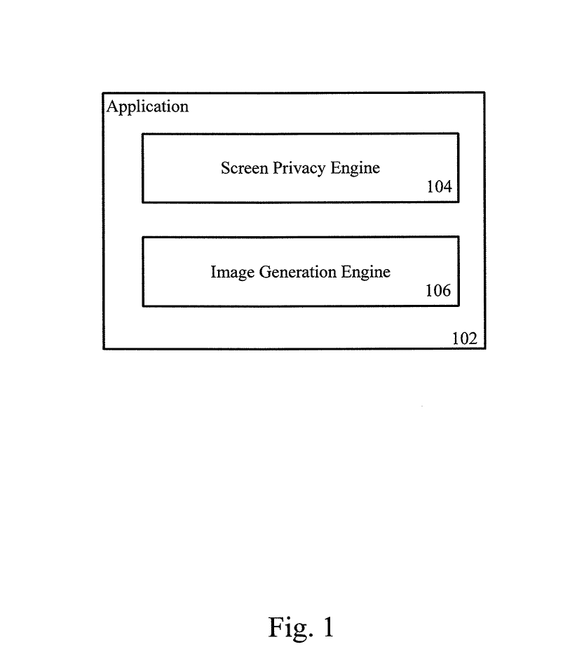

FIG. 1 illustrates an application 102 (e.g., desktop application, laptop application, mobile application, server application, add-on, security module, security patch or the like) that comprises one or more of a screen privacy engine 104, an image generation engine 106 and/or the like. It will be appreciated that the entities and/or engines illustrated in FIG. 1 are illustrated by way of example, and not by way of limitation. As such, it will be appreciated that one or more of the entities illustrated in FIG. 1 may be optional, or even eliminated, in some example embodiments. Further, in some example embodiments, the application 102 may include one or more other engines, modules or the like in addition to or in lieu of the engines illustrated in FIG. 1.

### Example Screen Privacy Engine

In some examples, the screen privacy engine 104 is configured to determine or otherwise receive an indication in which an application, such as application 102, is being sent to the background, minimized, reduced or is otherwise at least partially hidden to the user. In some examples, an application in the background may appear to a user as if the application is closed. For example, on some mobile devices, the operating system may allow each application to run in the background and will not close an application unless a user takes a series of steps.

In instances in which the application is being sent to the background (e.g., based on the activation of a home button), the application 102, the screen privacy engine 104 or the like may determine or otherwise capture the application current view. For example, the current view may comprise the current information, image or the like that was being displayed at the time the application was sent to the background. In some examples, the current view is the view at an application view stack top.

The application 102, the screen privacy engine 104 or the like may then determine whether the application current view contains sensitive information (e.g. personal identifiable information, a social security number, health records, financial records, passwords, information that may violate HIPPA or the like). The application 102, the screen privacy engine 104 or the like may determine the presence of sensitive information based on, for example, a predetermined indication that the current screen or instance of the current screen would normally include sensitive information, an indication provided by the application developer that such a screen would comprise sensitive information, a word search (e.g. search for word “SSN” or numbers in a pattern similar to an SSN, or the like), a screen scrape or other method for determining whether sensitive information is currently displayed. In some examples, the application 102, the screen privacy engine 104 or the like may consider all application views as sensitive.

The application 102, the screen privacy engine 104 or the like may cause a screensaver view, a redacted view, a view with the sensitive information hidden, a blank view or the like to be presented (e.g., pushed onto the application view stack top) in the visible view or on the screen of a device in an instance in which sensitive information is detected. In some examples, the screensaver is displayed prior to sending the current application view to the background (e.g., screensaver is added onto the top of the application view stack). Alternatively or additionally, the view of the screensaver may be added after a period of inactivity, after a predefined set of user steps. (e.g., suspicious activity) or the like. Advantageously, in an instance in which the application is returned to the foreground, the view displayed is the screensaver view and not that view that comprises the sensitive information.

As such, in an instance in which the application is being returned to the foreground, the screensaver view may be caused to be displayed. In some examples, and during the return to the foreground, the application 102, the screen privacy engine 104 or the like may perform one or more tasks to enable use of the application (e.g. refresh cached data). In some cases, upon completion of the one or more tasks, the application 102 may cause a current view to be displayed (e.g., the view last displayed prior to the transition to the background, a new logon screen, a session expired screen or the like) or may cause a challenge screen (e.g., a pin screen) that enables access to the application current view in an instance in which a correct response to the challenge is entered.

In some example embodiments, the application 102, the screen privacy engine 104 or the like may determine whether the application was in the background for a predetermined duration (e.g., 45 seconds). If the duration is exceeded, a user may, in such an example case, be prompted to authenticate or may be presented with the challenge screen described above.

### Example Screen Privacy Engine Implementation

In one non-limiting example, a profile view may be shown in an application current view. The profile view in such an example may include a patient identification number that may be classified as sensitive information. In an instance in which the application was pushed to the background (e.g. by pressing a home screen activation button, launching a new application, minimizing a current application or the like), a screensaver view may be added onto the applications view stack to block or otherwise hide the patient sensitive information.

In an instance in which the application is returned from the foreground (e.g., the application is selected from an application menu or icon display), the application or screen privacy engine may determine, in some examples, whether the application was in the background longer than a predetermined duration. In an instance in which the application is in the background longer than the predetermined duration, the user may be challenged prior to the display of the profile view (e.g., removing the screensaver view from the view stack).

In some examples, the application may determine that the application has returned to the foreground. In such a case, the application may perform one or more actions, such as a cached data refresh (if necessary) before the screensaver view is removed and the profile view is displayed.

In an instance in which the screensaver view is removed, the application (or the screen privacy engine 104) may then determine what information to show on the profile view (e.g., a determination about whether the patient identification number is to be redacted). In an instance in which a challenge is required, sensitive information in the profile view, such as the patient identification number, may be hidden or otherwise redacted when the profile view briefly appears and the user is presented with the challenge view. Once a user is re-authenticated, the challenge view may be removed and the profile view may be displayed with the sensitive information (e.g., the patient identification number).

### Example Application Workflow

In some examples and in an instance in which an application is pushed to the background, the operating system may notify the application so that the application can perform one or more tasks prior to being deactivated. In such cases, the application, such as via the screen privacy engine 104, may call a view controller method to cause a screensaver to be displayed or otherwise pushed onto the application view stack (e.g. An applicationDidEnterBackground method). In some examples, prior to calling the view controller, a determination may be made regarding whether the application current view contains sensitive information.

In some examples and in an instance in which an application returns to the foreground, the operating system may notify the application via an application foreground method (e.g., An applicationWillEnterForeground method). In some examples, the application, such as via screen privacy engine, may determine whether the application was in background long enough (e.g., for longer than a predefined duration, an inactivity timer has expired and/or the like) to cause the user to re-authenticate and set a challenge flag.

In some examples, the visible view controller or screensaver view controller that may, in some examples, be embodied by the screen privacy engine 104, may be notified in an instance in which the application is entering the foreground. In such a case, the view controller may determine whether to refresh the application current view or cause the application current view to be displayed by popping off the screensaver view from the application view stack.

In some examples, the view controller may then challenge a user in an instance in which the challenge flag is set. In an instance in which the challenge flag is set, the view controller, such as via the screen privacy engine 104, may hide or otherwise redact sensitive information in the application current view before the application current view is displayed. The view controller may then present a lock view. The lock view may cause the user to be prompted with a pin or password. In an instance in which a user is authenticated, the application current view may be displayed.

### Example Image Generation Engine

In some examples and as is described herein, the image generation engine 106 may be configured to input a one or more images (a single image in some example embodiments) that may be used for two or more of the available resolutions or display types (e.g. a retina display or a non-retina display). In some examples, the image generation engine 106 may be configured to modify an image that is to be displayed via in an application based on the size requirements outlined by in the application, a device form factor, a screen resolution or the like. In some examples, the provided image may therefore be provided in a maximum resolution.

As such, the image generation engine 106 may be configured to programmatically resize the image to fit the size requested by the application (e.g., for use in a title bar, for use as a button or the like). Such a resized image may be cached for subsequent use in some examples.

By way of a non-limiting example, an operating system may define the size of an image in terms of points (e.g., predefined size parameters) and not pixels. The points, in a non-optimized or low resolution display may be equal to the pixel value (e.g. 40 points is equal to 40 pixels), but in an optimized or high resolution display the points may be representative of one half the pixel value (e.g. 40 points is equal to 80 pixels). For example, given an image that is included in an application project that is 64×64 pixels, when the application running on an optimized display device resizes the image to 32×32 points, it will actually be rendered using the full 64×64 resolution. If the device running the application has a non-optimized (i.e., retina), the image may be scaled down to 32×32 pixels.

### Example Application Workflow

In some examples and in an instance in which an application starts or is otherwise launched, the application may load, such as via the image generation engine, images at the sizes they will be rendered into a cache for access when the application is creating a particular application view. As such, a single stored image that is 64×64 pixels may be resized to be appear on the toolbar as a 30×30 image and then may be saved in a cache under the name ‘toolbarTimeoff’. If the device has a an optimized display, the image may actually be resized to 60×60 pixels, but will be drawn in the same physical space as a 30×30 pixel image would be drawn on a non-optimized display.

In order to draw the image, the image generation engine 106 may be provided with an image context of a given size. Using the size, the image may be redrawn with the given size (e.g. height and width) to generate a new or scaled down image. The image may then be retrieved from the context where it was drawn and then may cached for use in the application. In some examples, the resized image may be retrieved from the cache and displayed in an application.

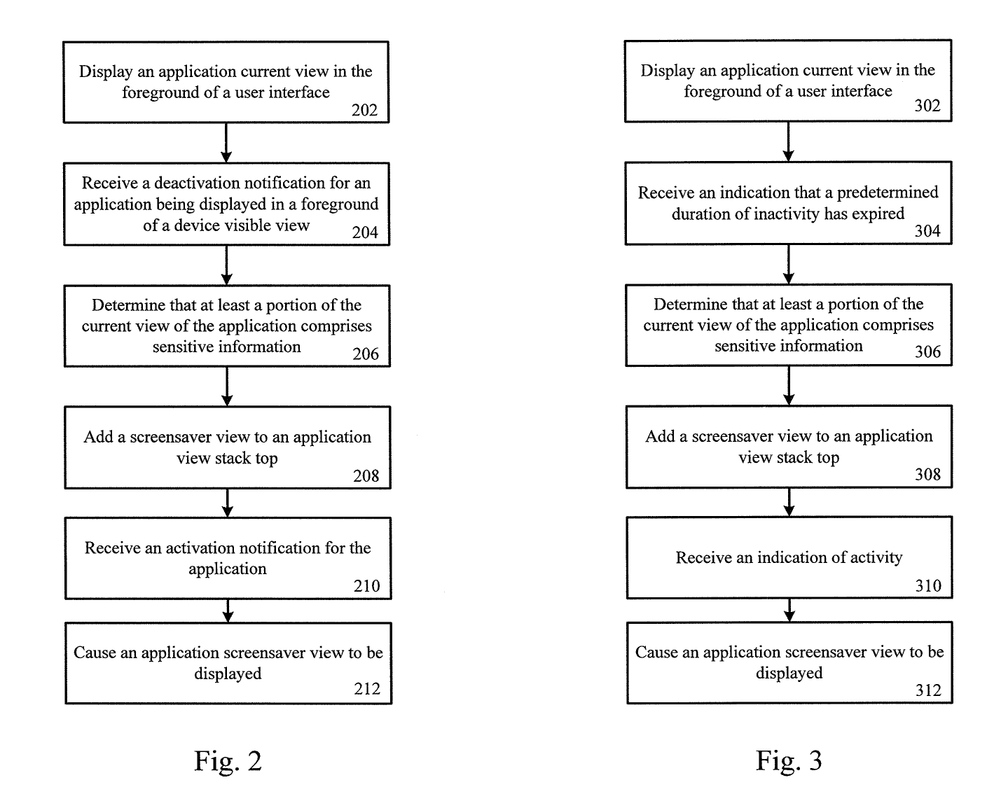

FIGS. 2-5 illustrate flowcharts of a system, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a server, desktop computer, laptop computer, mobile computer, or other computing device and executed by a processor (e.g., the processor 602) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowcharts' block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowcharts' block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts' block(s).

Accordingly, blocks or steps of the flowcharts support combinations of means for performing the specified functions and combinations of steps for performing the specified functions. It will also be understood that one or more blocks of the flowcharts, and combinations of blocks in the flowcharts, may be implemented by special purpose hardware-based computer systems which perform the specified functions or steps, or combinations of special purpose hardware and computer program product(s).

The below described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

FIG. 2 illustrates a flow diagram detailing a method for causing an application screensaver view to be displayed in an instance in which an application is returned from the background. At block 202, an application current view is displayed in the foreground of a user interface, a display or the like. In some examples, an operating system may allow a single application to run in the foreground, whereas other operating systems may allow multiple applications to operate in the foreground.

At block 204, a deactivation notification for an application being displayed in a foreground of a device visible view is received. In some examples, and as described herein, the application screensaver view may be placed onto the application view stack in an instance in which the application receives an indication that the application is being moved to the background.

At block 206, a determination about whether at least a portion of the current view of the application comprises sensitive information. In some examples, the application current view may contain sensitive information or other information that a user may want to remain private. Such sensitive information may be identified based on the view being classified as sensitive by the application, the view containing sensitive information that was discovered via word search, screen scrape or the like, the screen being identified as sensitive by the user or the like.

At block 210, a screensaver view is added to the application view stack top. At block 210, an indication that the application current view is to be returned to the foreground may be received. At block 212, an application screensaver view may be displayed when the application is returned to the foreground. In some examples, the screensaver view may be displayed in an instance in which the application was in the background for a predetermined amount of time. In some examples, the method ends after block 212, whereas in other examples the method may continue at block 402.

FIG. 3 illustrates a flow diagram detailing a method for causing an application screensaver view to be displayed in an instance in which a period of inactivity is detected. At block 302 an application current view may be displayed in the foreground of a user interface. At block 304, an indication that a predetermined period of inactivity has expired may be received.

At block 306, a determination is made as that at least a portion of the current view of the application comprises sensitive information. At block 308, a screensaver view is added to an application view stack top. At block 310, an indication of activity is received. For example, an indication of a swipe event, a mouse click or the like. At block 310, an application screensaver view is caused to be displayed in response to the detected activity. In some examples, the method ends after block 312, whereas in other examples the method may continue at block 402.

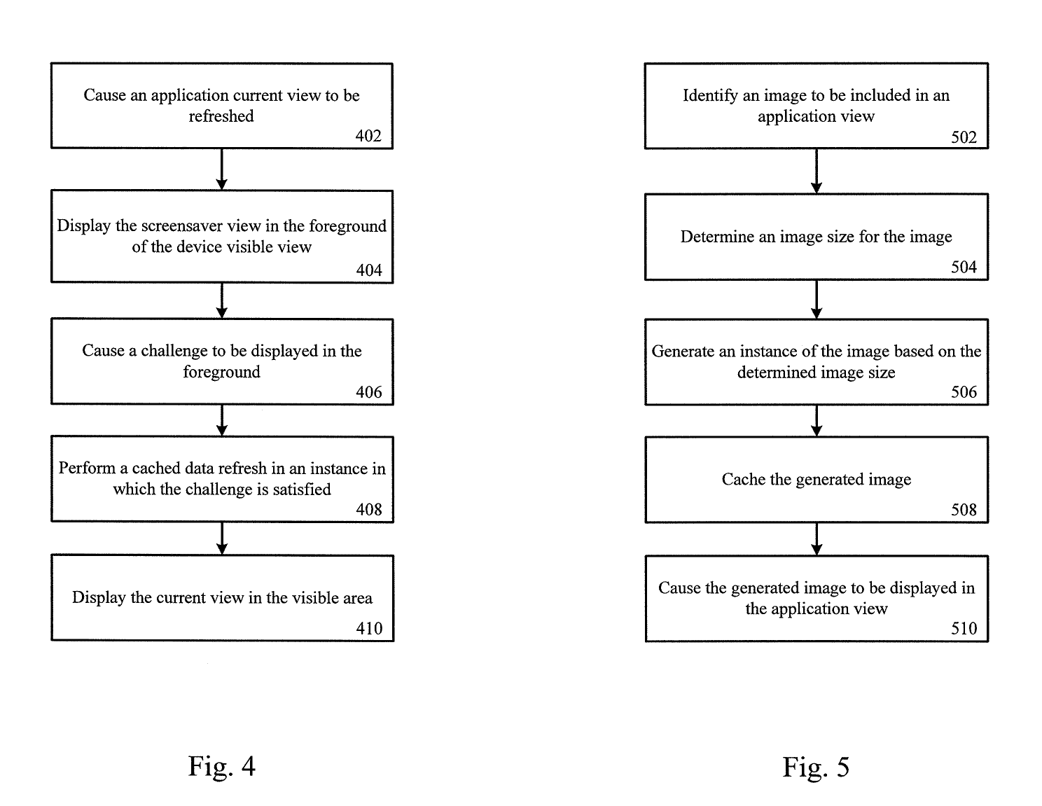

FIG. 4 illustrates a flow diagram detailing a method for causing an application current view to be displayed subsequent to the display of a screensaver view. In some examples, the screensaver view may have been displayed as a result of the application being returned from the background (e.g., FIG. 2) or as a result of a period of inactivity (e.g., FIG. 3). At block 402 an application current view is caused to be refreshed. In some examples, this may result in the application current view being updated, data in the view being updated and/or the like. For example, the current location of the device on a map may be updated. In some examples, an activity indicator may be displayed in an instance in which the current view is being refreshed; a call to a server is occurring and/or the like.

At block 404, an application screensaver or redacted view may be caused to be displayed in the foreground of the device visible view. In some examples, the application redacted view may take the form of the application current view with at least a portion, if not all, of the sensitive information redacted or otherwise hidden. In some examples the redacted view is created by the view controller and may be presented until the challenge view of block 406 is displayed.

At block 406, a cached data refresh may be performed in an instance in which the challenge is satisfied in some example embodiments. At block 408, a determination is made about whether a proper challenge was entered. At block 410, an application current view is caused to be displayed in an instance in which the proper challenge was entered at block 408.

FIG. 5 illustrates a flow diagram detailing a method for causing an image to be generated. At block 502, an image to be included in an application view is included. For example, an image to be included may be an image that is loaded by the application during application startup.

At block 504, an image size is determined for the image. In some examples, the image size may be defined by the application view. For example, an image that is used in a title bar may be of a different size then an image that is be used as an icon. At block 508, the generated image may be cached. At block 510, the generated imaged may be caused to be displayed in an application view.

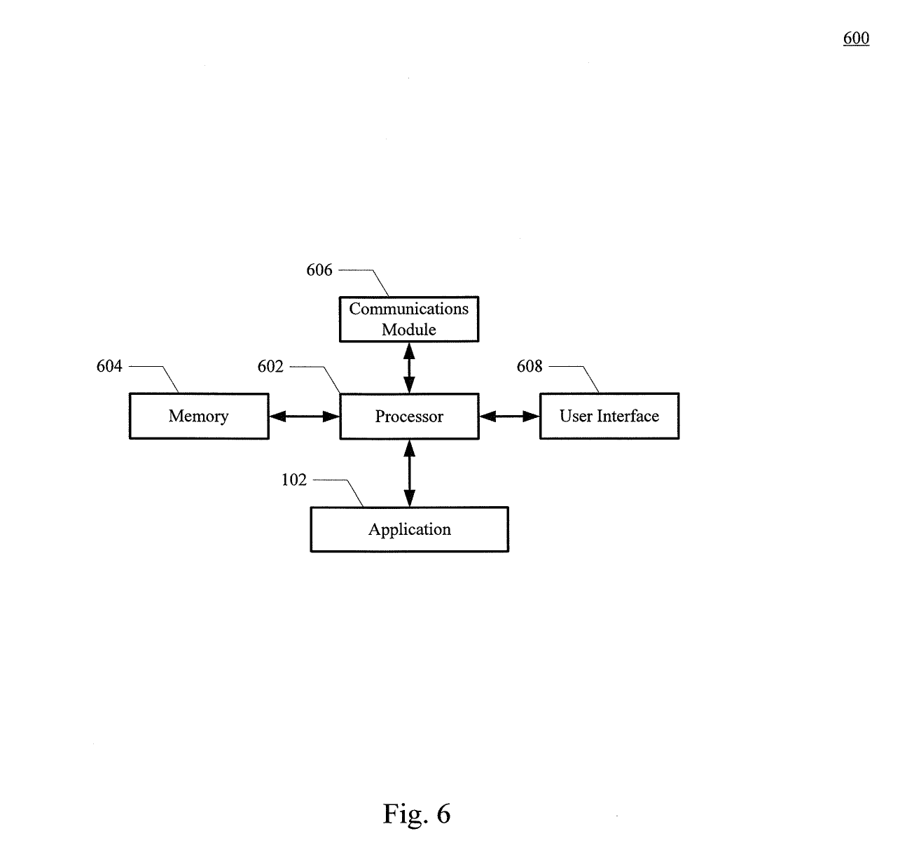

FIG. 6 illustrates a schematic block diagram of circuitry 600 that may include, enable or otherwise be used in conjunction with application 102, screen privacy engine 104, image generation engine 106 or the like. As illustrated in FIG. 6, in accordance with some example embodiments, circuitry 600 may include various means, such as a processor 602, memory 604, communication module 606, user interface 608 and/or application 102.

As referred to herein, “module” includes hardware, software and/or firmware configured to perform one or more particular functions. In this regard, the means of circuitry 600 as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., memory 604) that is executable by a suitably configured processing device (e.g., processor 602), or some combination thereof.

Processor 602 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 6 as a single processor, in some embodiments, processor 602 comprises a plurality of processors. The plurality of processors may be embodied on a single computing device or may be distributed across a plurality of computing devices collectively configured to function as circuitry 600. The plurality of processors may be in operative communication with each other and may be collectively configured to perform one or more functionalities of circuitry 600 as described herein. In an example embodiment, processor 602 is configured to execute instructions stored in memory 604 or otherwise accessible to processor 602. These instructions, when executed by processor 602, may cause circuitry 600 to perform one or more of the functionalities of circuitry 600 as described herein.

Whether configured by hardware, firmware/software methods, or by a combination thereof, processor 602 may comprise an entity capable of performing operations according to embodiments of the present invention while configured accordingly. Thus, for example, when processor 602 is embodied as an ASIC, FPGA or the like, processor 602 may comprise specifically configured hardware for conducting one or more operations described herein. As another example, when processor 602 is embodied as an executor of instructions, such as may be stored in memory 604, the instructions may specifically configure processor 602 to perform one or more algorithms and operations described herein.

Memory 604 may comprise, for example, volatile memory, non-volatile memory, or some combination thereof. Although illustrated in FIG. 6 as a single memory, memory 604 may comprise a plurality of memory components. The plurality of memory components may be embodied on a single computing device or distributed across a plurality of computing devices. In various embodiments, memory 604 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 604 may be configured to store information, data, applications, instructions, or the like for enabling circuitry 600 to carry out various functions in accordance with example embodiments discussed herein. For example, in at least some embodiments, memory 604 is configured to buffer input data for processing by processor 602. Additionally or alternatively, in at least some embodiments, memory 604 may be configured to store program instructions for execution by processor 602. Memory 604 may store information in the form of static and/or dynamic information. This stored information may be stored and/or used by circuitry 600 during the course of performing its functionalities.

Communications module 606 may be embodied as any device or means embodied in circuitry, hardware, a computer program product comprising computer readable program instructions stored on a computer readable medium (e.g., memory 604) and executed by a processing device (e.g., processor 602), or a combination thereof that is configured to receive and/or transmit data from/to another device, such as, for example, a second circuitry 600 and/or the like. In some embodiments, communications module 606 (like other components discussed herein) can be at least partially embodied as or otherwise controlled by processor 602. In this regard, communications module 606 may be in communication with processor 2602, such as via a bus. Communications module 606 may include, for example, an antenna, a transmitter, a receiver, a transceiver, network interface card and/or supporting hardware and/or firmware/software for enabling communications with another computing device. Communications module 606 may be configured to receive and/or transmit any data that may be stored by memory 604 using any protocol that may be used for communications between computing devices. Communications module 606 may additionally or alternatively be in communication with the memory 604, user interface 608 and/or any other component of circuitry 600, such as via a bus.

User interface 608 may be in communication with processor 602 to receive an indication of a user input and/or to provide an audible, visual, mechanical, or other output to a user. Some example visual outputs that may be provided to a user by circuitry 600 are discussed in connection with the displays described above. As such, User interface 608 may include support, for example, for a keyboard, a mouse, a joystick, a display, an image capturing device, a touch screen display, a microphone, a speaker, a RFID reader, barcode reader, biometric scanner, and/or other input/output mechanisms. In embodiments wherein circuitry 600 is embodied as a server or database, aspects of user interface 608 may be reduced as compared to embodiments where circuitry 600 is implemented as an end-user machine (e.g., consumer device and/or merchant device) or other type of device designed for complex user interactions. In some embodiments (like other components discussed herein), user interface 608 may even be eliminated from circuitry 600. User interface 608 may be in communication with memory 604, communications module 606, and/or any other component(s), such as via a bus. Although more than user interface and/or other component can be included in circuitry 600, only one is shown in FIG. 6 to avoid overcomplicating the drawing (like the other components discussed herein).

Application 102 may also be included. In some embodiments, some or all of the functionality of the application 102 may be performed by processor 602. In this regard, the example processes and algorithms discussed herein (e.g., FIGS. 2-5) can be performed by at least one processor 602. For example, non-transitory computer readable storage media can be configured to store firmware, one or more application programs, and/or other software, which include instructions and other computer-readable program code portions that can be executed to control processors of the components of circuitry 600 to implement various operations, including the examples shown above. As such, a series of computer-readable program code portions may be embodied in one or more computer program products and can be used, with a computing device, server, and/or other programmable apparatus, to produce the machine-implemented processes discussed herein.

Any such computer program instructions and/or other type of code may be loaded onto a computer, processor or other programmable apparatuses circuitry to produce a machine, such that the computer, processor other programmable circuitry that executes the code may be the means for implementing various functions, including those described herein.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

That which is claimed:

1. A method comprising:
receiving a deactivation notification for an application being displayed in a foreground of a device visible view, the deactivation notification providing an indication that the application is to be pushed to the background;
determining, using a processor, that at least a portion of the current view of the application comprises sensitive information; and
adding a screensaver view to an application view stack top, wherein the screensaver view is operable to at least partially obscure the sensitive information in at least a portion of the current view.

2. The method of claim 1, further comprising:
causing the application to be pushed to the background.

3. The method of claim 1, further comprising:
receiving an activation notification for the application, the activation notification providing an indication that the application is to be pushed to the foreground.

4. The method of claim 3, further comprising:
displaying the screensaver view in the foreground of the device visible view; and
displaying the current view in the device visible view by popping the screensaver view off of the application view stack.

5. The method of claim 4, further comprising determining whether to perform a cached data refresh.

6. The method of claim 3, further comprising:
determining that the application was in the background for a duration that exceeds a predetermined threshold; and
causing a challenge to be displayed in the foreground, wherein the challenge requires at least one of a correct password or personal identification number for authentication.

7. The method of claim 6, further comprising:
performing a cached data refresh in an instance in which the challenge is satisfied; and
displaying the current view in the visible area.

8. The method of claim 1, wherein the deactivation notification is received from an operating system.

9. The method of claim 1, wherein the current view is the screen at the application view stack top.

10. The method of claim 1, wherein the screensaver view is at least one of a redacted current view or a predesigned screensaver.

11. The method of claim 1, wherein sensitive information is determined based on at least one of the current view being classified as sensitive by the application, the current view containing sensitive information based on a word search or screen scrape or the current view being identified as sensitive by the user.

12. An apparatus comprising:
a processor; and
a memory including computer program code, the memory and the computer program code configured to, with the processor, cause the apparatus to at least:
receive a deactivation notification for an application being displayed in a foreground of a device visible view, the deactivation notification providing an indication that the application is to be pushed to the background;
determine that at least a portion of the current view of the application comprises sensitive information; and
add a screensaver view to an application view stack top, wherein the screensaver view is operable to at least partially obscure the sensitive information in at least a portion of the current view.

13. The apparatus of claim 12, wherein the memory including the computer program code is further configured to, with the processor, cause the apparatus to:
cause the application to be pushed to the background.

14. The apparatus of claim 12, wherein the memory including the computer program code is further configured to, with the processor, cause the apparatus to:
receive an activation notification for the application, the activation notification providing an indication that the application is to be pushed to the foreground.

15. The apparatus of claim 14, wherein the memory including the computer program code is further configured to, with the processor, cause the apparatus to:
display the screensaver view in the foreground of the device visible view; and
display the current view in the device visible view by popping the screensaver view off of the application view stack.

16. The apparatus of claim 15, wherein the memory including the computer program code is further configured to, with the processor, cause the apparatus to determine whether to perform a cached data refresh.

17. The apparatus of claim 14, wherein the memory including the computer program code is further configured to, with the processor, cause the apparatus to:
determine that the application was in the background for a duration that exceeds a predetermined threshold; and
cause a challenge to be displayed in the foreground, wherein the challenge requires at least one of a correct password or personal identification number for authentication.

18. The apparatus of claim 17, wherein the memory including the computer program code is further configured to, with the processor, cause the apparatus to:
perform a cached data refresh in an instance in which the challenge is satisfied; and
display the current view in the visible area.

19. The apparatus of claim 12, wherein the current view is the screen at the application view stack top and wherein the screensaver view is at least one of a redacted current view or a predesigned screensaver.

20. A computer program product comprising at least one non-transitory computer readable storage medium, the non-transitory computer readable storage medium storing instructions that, when executed by a processor, cause the processor to configure an apparatus to at least:
receive a deactivation notification for an application being displayed in a foreground of a device visible view, the deactivation notification providing an indication that the application is to be pushed to the background;
determine that at least a portion of the current view of the application comprises sensitive information; and
add a screensaver view to an application view stack top, wherein the screensaver view is operable to at least partially obscure the sensitive information in at least a portion of the current view.
